(19) United States
(12) Patent Application Publication
(10) Pub. No.: US 2010/0063764 A1
(43) Pub. Date: Mar. 11, 2010

(54) USE OF DIFFERENT PAIRS OF OVERLAY LAYERS TO CHECK AN OVERLAY MEASUREMENT RECIPE

(76) Inventors: Limin Lou, Milpitas, CA (US); Johnson Lim, San Jose, CA (US); Fenghong Zhang, Sunnyvale, CA (US); Ching-Hwa Chen, Milpitas, CA (US)

Correspondence Address: Haynes and Boone, LLP;IP Section, 2323 Victory Avenue, SUITE 700, Dallas, TX, 75219, US

(21) Appl. No.: 12/208,140

(22) Filed: Sep. 10, 2008

(51) Int. Cl. G01P 21/00

(52) U.S. Cl. 702/94

(57) ABSTRACT

An overlay measurement recipe is checked for reliability as follows. A first pair of overlay layers (130, 150) is formed (610), and the recipe is used to obtain alignment measurements for the two layers. Then another pair of overlay layers (130, 150) is obtained (630), possibly using the same masks, but this time at least one of the layers (150) is offset from its previous position. The overlay measurement recipe is used again to obtain alignment measurements (640). The two sets of measurements are checked against the offset of the layers from their previous positions to validate the recipe. Other embodiments are also provided.

### BACKGROUND OF THE INVENTION

The present invention relates to lithography, and more particularly to checking an overlay measurement recipe.

A typical semiconductor integrated circuit is made of multiple patterned layers manufactured in alignment with each other. These layers are checked for alignment errors (overlay errors) during fabrication. FIG. 1 illustrates a semiconductor wafer 110 containing a substrate 120 which may include a silicon substrate and possibly other layers. A patterned layer 130 has been formed on substrate 120. Another layer 140 has been formed over layer 130 and must now be patterned to provide features aligned with layer 130 and possibly with some features in substrate 120. To pattern the layer 140, the wafer is coated with a photoresist layer 150 and placed on a stage 160 of a tool 164 that will expose the photoresist to light emitted by the tool's light source 170. On the way to wafer 110, the light will pass through an optical mask 174 having a pattern of optical features corresponding to a pattern to be formed in layer 140. The tool's control circuit 180 controls the light source 170, the stage 160 and other components, e.g. optical components (not shown). The operation of control circuit 180 is guided by an externally generated exposure recipe 184.

After the exposure, the photoresist layer 150 is developed, and then examined in a metrology tool 304 (FIG. 3) for alignment to layer 130 and possibly other features. For that purpose, the wafer is placed on the tool's stage 310 and exposed to light emitted by light source 320. The light reflected by the wafer is collected by sensors 330 and analyzed by analysis and control block 350 to determine if the patterned photoresist layer 150 is properly aligned to the underlying features. The light spectral composition can be chosen so that layer 140 is transparent. Layer 140 can also be absent, as for example in the case when photoresist 150 forms a mask for ion implantation into layer 130.

In tool 304, block 350 controls the sensors 330, the light source 320, and the stage 310 to operate in accordance with an overlay measurement recipe 360 provided to tool 304. The recipe 360 defines which wafer portions are to be examined by tool 304 and how. For example, a feature in wafer 110 may cause the sensors 330 to generate a pulse of an irregular shape such as shown in FIG. 4. The block 350 determines the feature's location by “slicing” the pulse at some level L, i.e. by determining the spacial coordinates x₀ and x₁ at which the pulse crosses the level L, and then determining the feature's location as the average (x₀+x₁)/2. Clearly, this measured location depends on the level L, which may be specified by the overlay measurement recipe 360. Recipe 360 may also specify the wavelength to be provided by light source 320, optical parameters for controlling the focusing optics (not shown) which transmits the light to and from the wafer, and possibly other parameters. These parameters may be chosen depending on a number of factors including, for example, the materials of layers 150, 140, 130; the feature geometry (e.g. possible shadowing of light by these features); and perhaps other factors designed to reduce noise and provide reliable measurements. Generation of a reliable overlay measurement recipe 360 is an important part of the set-up of the fabrication process.

If the measurement results obtained by tool 304 are unsatisfactory, the wafer may have to be reworked. For example, photoresist 150 and possibly underlying layers may have to be stripped and re-deposited. Alternatively, the wafer may be discarded.

To generate a reliable overlay measurement recipe 360, an engineer may try different recipe versions. The measurements provided by each recipe version may be checked by slicing the wafer and examining the wafer's cross section. This is a time consuming process. It is desirable to provide a simple test that could identify at least some problematic recipes-based measurements without slicing the wafer.

### SUMMARY

This section summarizes some features of the invention. Other features may be described in the subsequent sections. The invention is defined by the appended claims, which are incorporated into this section by reference.

Some embodiments of the present invention provide tests capable of detecting at least some problematic results of recipe-based measurements. In some embodiments, an overlay measurement recipe is checked as follows. First, a test wafer is processed as in FIGS. 1-3, and a first set of measurement results is obtained. The measurement results include overlay errors, e.g. a translation or rotation of patterned photoresist layer 150 relative to a desired alignment with layer 130. Then the photoresist 150 is stripped, re-deposited, and the wafer is reprocessed as in FIGS. 1-3, but this time the exposure recipe 184 is modified to offset the pattern in photoresist 150 by some amount. New measurement results (a “second” set of measurement results) are obtained from the overlay measurement tool 304 (FIG. 3). Ideally, the second set of measurement results should match the first set as modified by the offset of patterned photoresist 150. For example, if the first set of measurements showed photoresist layer 150 as shifted in some direction (e.g. X direction) by 3 nm from the ideal position, and the exposure recipe 184 was then modified to offset the pattern in photoresist 150 in the X direction by −2 nm (i.e. to shift the pattern by 2 nm in the negative X direction), then the second set of measurements must indicate the shift of photoresist 150 in the X direction by 1 nm or by an amount close to 1 nm. If the second set of measurement results is inconsistent with the first set combined with the offset, then either the tool 304 (FIG. 3) or the tool 164 (FIG. 1) or both do not operate in a reliable fashion. In particular, the overlay measurement recipe 360 may be unreliable.

The invention is not limited to the features and advantages described above except as defined by the appended claims.

### BRIEF DESCRIPTION OF THE DRAWINGS

FIG. 1 is a side view of a photolithographic exposure system according to prior art, with a wafer shown in a vertical cross section.

FIG. 2 shows a vertical cross section of a wafer in a prior art process of fabrication.

FIG. 3 is a side view of an overlay measurement system according to prior art, with a wafer shown in a vertical cross section.

FIG. 4 illustrates a signal obtained by the system of FIG. 3.

FIG. 5 is a top view of a wafer with test structures used in some embodiments of the present invention.

FIG. 6 is a flowchart of a method for checking an overlay measurement recipe, the method being an embodiment of the present invention.

FIG. 7 is a table of exemplary test data that can be obtained by the method of FIG. 6.

FIGS. 8A, 8B are top views of possible wafer positions illustrating some of the measurements performed to obtain the data of FIG. 7.

FIG. 8C illustrates positions of X and Y axes on a wafer when some of the measurements are performed to obtain the data of FIG. 7.

FIG. 8D is a top view of possible wafer positions illustrating some of the measurements performed to obtain the data of FIG. 7.

FIG. 9 is a top view of exposure fields in a wafer for the exposure system of FIG. 1.

FIGS. 10A, 10B are top views of exposure fields in different exposure operations.

FIG. 11 is a table of exemplary test data that can be obtained by the method of FIG. 6.

### DESCRIPTION OF SOME EMBODIMENTS

The embodiments described in this section illustrate but do not limit the invention. In particular, the invention is not limited to specific overlay measurement recipes or measurements or to types of exposure tool 164 or metrology tool 304 except as defined by the appended claims. The exposure tool 164 can be a stepper, a scanner, a tool that exposes the entire wafer in a single exposure, or perhaps some other type. (One suitable stepper is ASML XT 1250 (Trademark) available from ASML Holding N.V., De Run 6501, 5504 DR Veldhoven, The Netherlands.) The invention is defined by the appended claims.

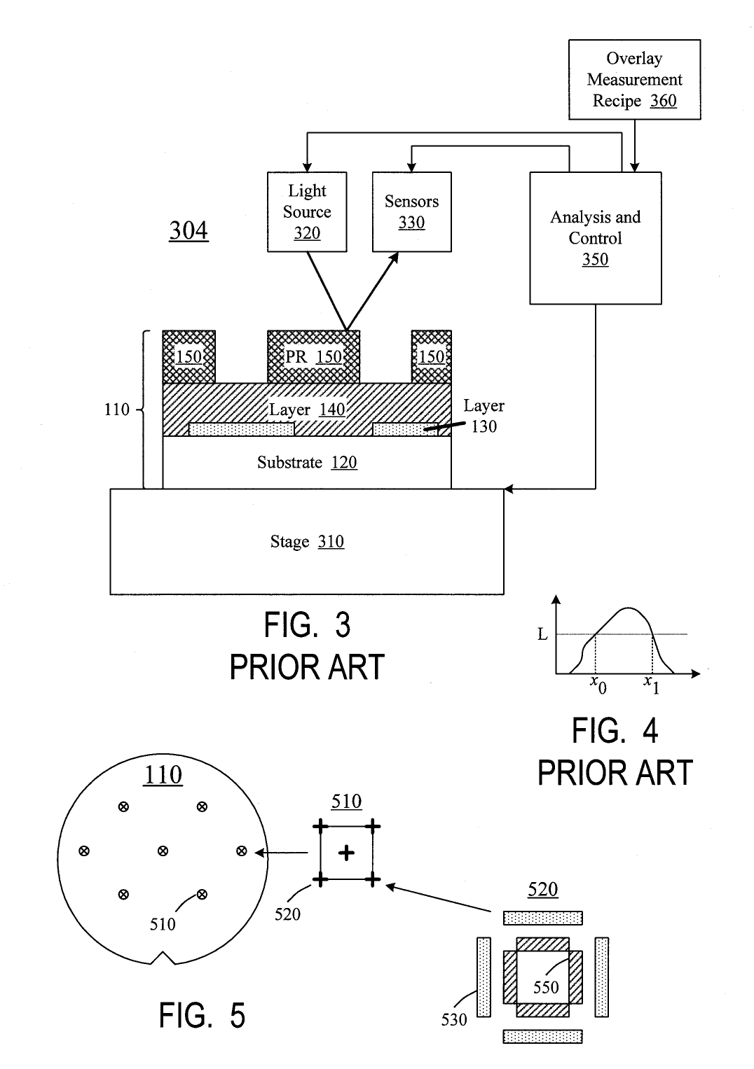

FIG. 5 presents a top view of an exemplary wafer that can be used to test an overlay measurement recipe. The wafer has a number of measurement sites 510 located on the scribe lines, at the periphery, and/or possibly in other positions. Each measurement site 510 includes one or more registration targets 520. In the example of FIG. 5, there are five targets 520 at each site 510; the targets' centers are located at the four corners and the center of a square. Each target 520 is a frame-in-frame type (sometimes called “box in box”). The outer frame (or “box”) 530 consists of four bars arranged along four sides of a square. The bars can be made, for example, as mesas of layer 130 (FIG. 2), or as trenches in layer 130, or in some other way detectable by the metrology tool 304 of FIG. 3. The inner frame (or “box”) 550 also consists of four bars arranged along four sides of a square. The bars can be made, for example, of photoresist layer 150 (FIG. 2), or as spaces in photoresist layer 150, or in some other way detectable by metrology tool 304. In top view, if there are no overlay errors, box 550 can be geometrically obtained by shrinking the box 530 towards the box's center. Thus, frames 530 and 550 are concentric if there are no overlay errors. Other types of targets, e.g. including sets of parallel bars or some other types, are also possible.

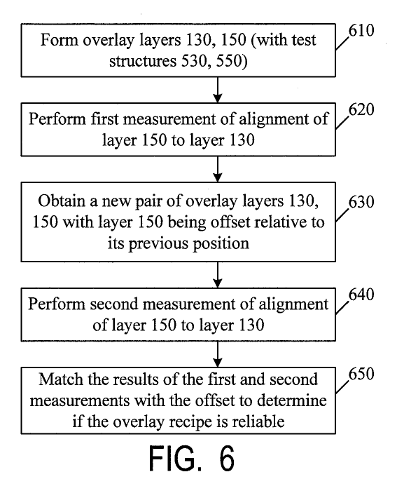

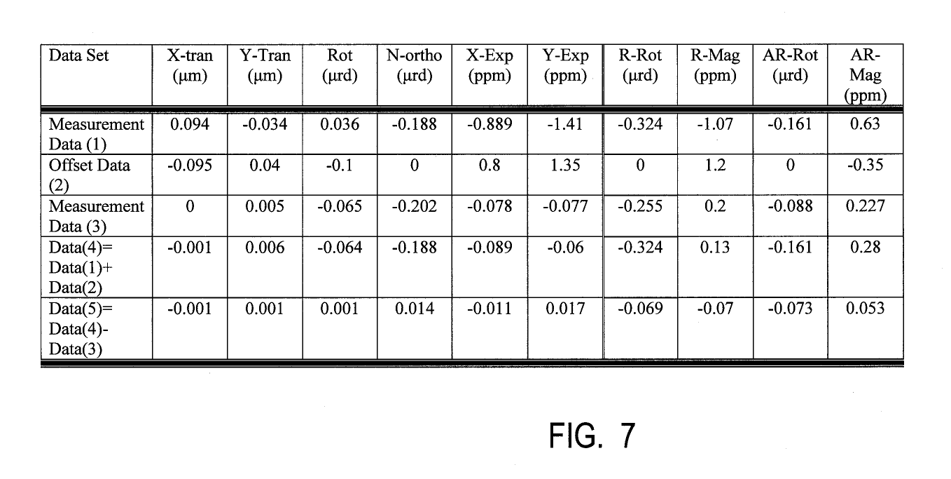

FIG. 6 is a flowchart of an exemplary method for validating an overlay measurement recipe 360 (FIG. 3). At step 610, layers 130, 140, 150 are manufactured using the exposure tool 164. (Layer 140 may be omitted as explained above.) This step can be done using prior art methods described above. At step 620, overlay measurements are performed by metrology tool 304 according to recipe 360. The measurements may use registration targets 510, and may be performed by prior art methods. FIG. 7 illustrates exemplary measurements, described in more detail below, as “Measurement Data (1)”.

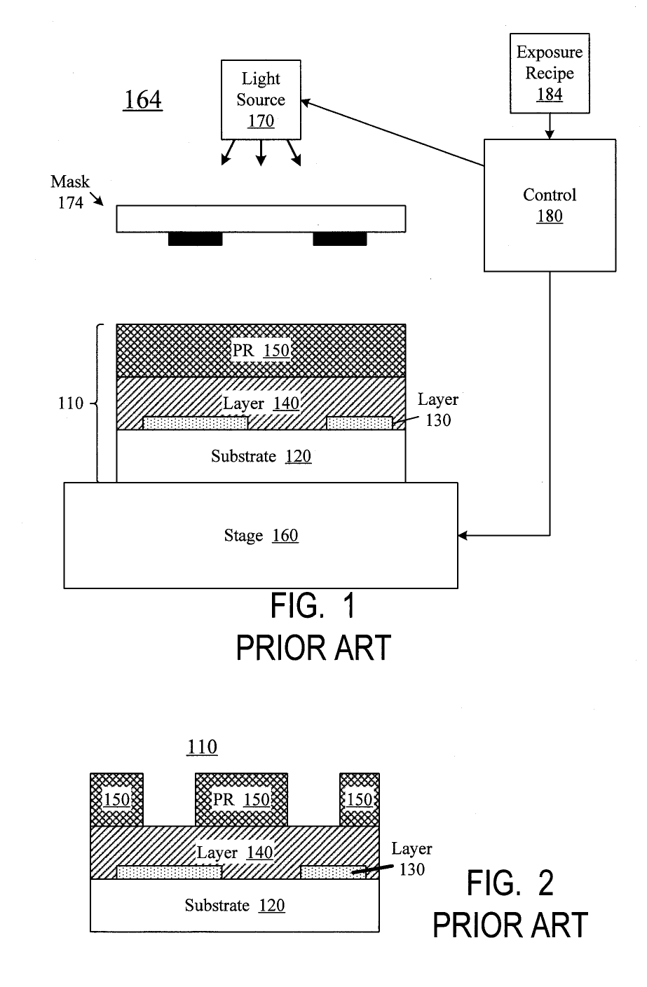

At step 630, a new pair of layers 130, 150 is obtained, but with layer 150 being offset from its previous position. These layers 130, 150 may be provided in the same wafer. For example, layers 130, 140 may be unchanged, but layer 150 may be stripped and then re-deposited and patterned again, using the same mask 174 (FIG. 1) as at step 610. Mask 174 can be shifted in tool 304 relative to its position at step 610 and/or the exposure tool 164 can be controlled to provide different offsets for different positioning parameters, as illustrated for some embodiments in the line “Offset Data (2)” in the table of FIG. 7 and explained below.

In some embodiments, both layers 130 and 150 (and possibly underlying layers) are stripped and re-deposited at step 630 in the same wafer as was used in steps 610, 620. If layer 140 is used, it may also be stripped and re-deposited. In still other embodiments, layers 130, 150 are made in a different wafer.

At step 640, overlay measurements are performed on the layers 130, 150 obtained according to step 630. The measurements are performed with tool 304 using recipe 360. Exemplary measurement results are shown as “Measurement Data (3)” in FIG. 7.

At step 650, a check is performed to determine if the measurement data obtained at step 640 are consistent with the measurement data obtained at step 620 and the offsets used at step 630. For example, the measurement parameters obtained at step 620 (Measurement Data (1) in FIG. 7) can be added with the offsets, and the sum (“Data (4)” in FIG. 7) can be compared with the measurement data obtained at step 640 (via computing the difference “Data(5)” in FIG. 7). If the comparison is acceptable (e.g. if the difference between Data(4) and Data(5) is within some tolerance levels), then the overlay measurement recipe is considered to pass the test, although additional tests can also be performed. If the comparison is unacceptable, then the test is considered as failed.

Layer 150 can be any photosensitive layer, e.g. photosensitive polyimide. Alternatively, layer 150 can be non-photosensitive, and can be patterned using a photosensitive layer.

Each of layers 130, 150 is an “overlay layer” in the sense that the two layers are defined using different photolithographic exposures, possibly with different masks 174, and hence the two layers need to be aligned to each other. However, different overlay layers can be made from a single layer, e.g. from layer 150, if different features in layer 150 are defined by respective different photolithographic exposures, possibly with different masks 174, and an alignment check is needed for aligning these features to each other. In such cases, features 530 can be defined in one of the photolithographic exposures and features 550 can be defined in another one of the photolithographic exposures. Further, the invention is not limited to photolithography but can be applied to maskless lithography, e.g. electron-beam lithography or other methods to define a pattern on a wafer. The wafer may be a semiconductor wafer, a glass wafer (e.g. of a type used in liquid crystal displays), or possibly some other type of wafer.

FIG. 7 illustrates parameters measured by metrology tool 304 of type Archer AIM available from KLA-Tencor of California. The invention is not limited to this tool or to specific parameters however except as defined by the appended claims.

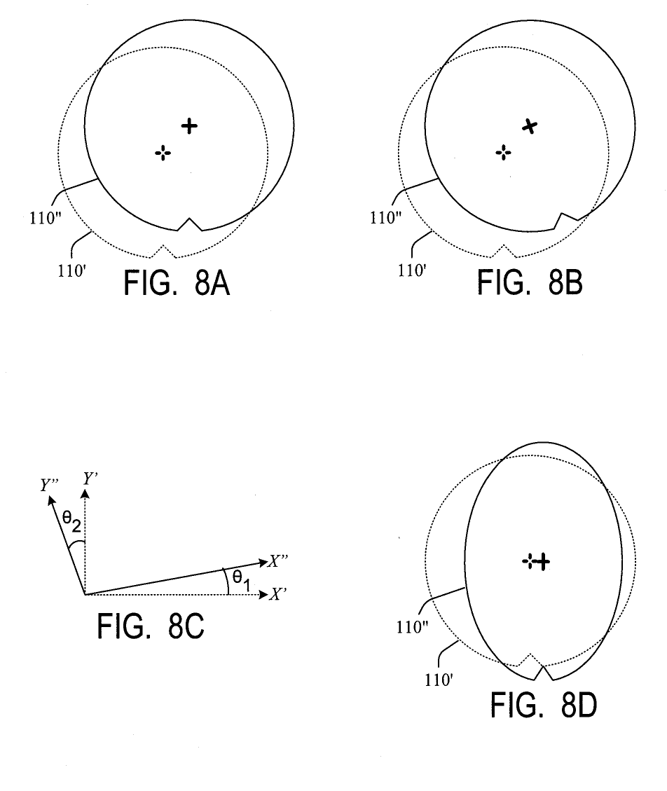

In FIG. 7, “X-Tran” and “Y-Tran” denote the wafer translation along the X and Y axes respectively, as illustrated in FIG. 8A. The positions of wafer 110 in tool 164 at steps 610 and 630 are shown respectively at 110′ and 110″ in FIG. 8A and subsequent figures. The center of position 110′ is marked with a dotted cross, and the center of position 110″ with a non-dotted cross. The X and Y axes are determined by tool 304 from wafer markings as known in the art. The X- and Y-translation values are measured in micrometers in this example.

“Rot” (measured in microradians) in FIG. 7 denotes the wafer rotation. As shown in FIG. 8B, the wafer can be both shifted and rotated at step 630 relative to the wafer position 110′ at step 610.

“N-ortho” (non-orthogonality, in microradians) is illustrated in FIG. 8C. The positions of the X and Y axes in tool 164 at step 610 are shown respectively by axes X′ and Y′ in FIG. 8C. The X and Y axes' positions at step 630 are shown by axes X″ and Y″. The non-orthogonality is defined as the difference θ₂−θ₁ where θ₁ is the angle between the axes X′ and X″ and θ₂ is the angle between the axes Y′ and Y″.

The parameters “X-Exp” and “Y-Exp” (X-expansion and Y-expansion, in parts per million) specify the expansion along the X and Y axes respectively of the image printed in resist 150 as illustrated in FIG. 8D. The parameter value should be multiplied by 10⁻⁶ and by the wafer radius (e.g. 100 mm for a 200 mm wafer) to obtain the total expansion of the image.

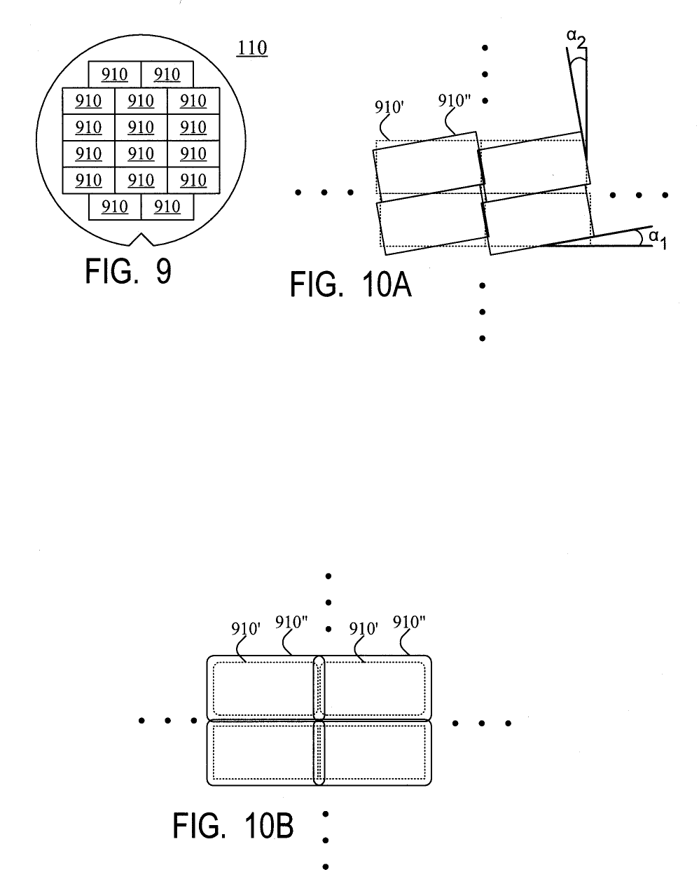

The parameters described above (i.e. X- and Y-translation, rotation, “N-ortho” and X- and Y-expansion) are called “interfield” as they describe misalignment of the whole wafer. The remaining parameters are intrafield, i.e. they describe misalignment of an individual exposure field 910 (FIG. 9) in wafer 110. The exposure system 164 (FIG. 1) may be a stepper, exposing a single field 910 at a time. Each field 910 contains one or more dies. Stage 160 moves as needed to expose different fields 910.

In FIGS. 10A and 10B, the positions of fields 910 in tool 164 at steps 610 and 630 are shown respectively at 910′ and 910″. As shown in FIG. 10A, each field 910 can be twisted at step 630 relative to step 610. The twist involves a rotation of the horizontal sides of each field by some angle α₁, and of the vertical sides by an angle α₂. The R-Rot parameter in FIG. 7 is defined as (α₁+α₂)/2, and the asymmetric rotation AR-Rot is defined as (α₂−α₁)/2. Both parameters are measured in microradians, and can be averaged over all the fields to obtain the value in FIG. 7.

R-Mag (magnification) and AR-Mag (asymmetric magnification) describe the magnification of a field 910 in parts per million (ppm). See FIG. 10B. Suppose a field 910 is magnified (expanded) by some value “Mx” in the X direction (horizontal direction) and by “My” in the Y direction. Then “R-Mag” is defined as (Mx+My)/2, and “AR-Mag” is defined as (Mx−My)/2. Negative values of magnification denote shrinkage. Each of R-Mag and AR-Mag can be averaged over all the fields 910 to obtain the value in FIG. 7.

In some embodiments, the matching step 650 of FIG. 6 involves comparing each parameter in Data(5) with 2 nm. In this comparison, the parameters measured in microradians (e.g. the Rot parameter) are multiplied by the wafer radius. The ppm parameters (e.g. X-expansion) are multiplied by the wafer radius and by 10⁻⁶. If the values so obtained are all below 2 nm, the test is considered as passed. If any value is at or above 2 nm, the test is considered as failed. Other types of matching are also possible.

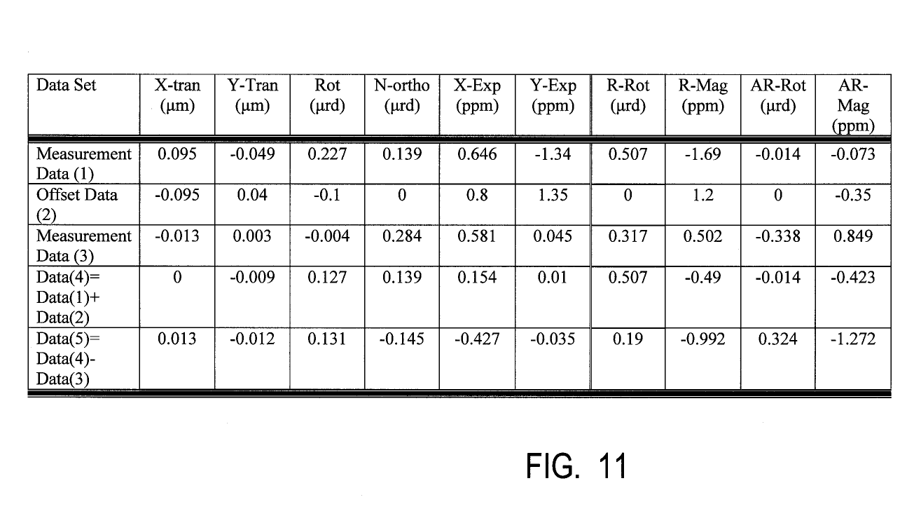

If the test consists in checking that all the parameters are below 2 nm, and the wafer radius of 100 mm, then the data of FIG. 7 indicate that the test is passed, and the data of FIG. 11 indicate that the test is failed.

Some embodiments provide a method for checking an overlay measurement recipe, the method comprising the following operations (a) through (g). Operation (a) consists in obtaining first data specifying a first set of one or more values for one or more overlay parameters, each overlay parameter specifying a property of an alignment of a subsequent overlay layer (e.g. layer 150) with respect to a previous overlay layer (e.g. layer 130). For example, the overlay parameters may be X-translation, Y-translation, and other parameters in FIG. 7, or some other parameters. The first set of values of these parameters may consist of values used at step 610 (FIG. 6). In embodiments described above, these values were all zeroes, but non-zero values are also possible.

The first data can specify the first set of values indirectly. For example, the first data can specify the X-translation and other parameters separately for the layer 130 and the layer 150. Thus, at step 610, one may produce the layer 130 with the X-translation of 0.5 μm and the layer 150 with the X-translation of 0.54 μm. Then in the first set of values, the X-translation will be 0.54−0.5=0.04 μm. In another example, if the X-translation values are 0.5 μm for both layers 130 and 150, then in the first set of values the X-translation will be 0 as in the embodiment of FIG. 7.

Operation (b) consists in obtaining a first pair of overlay layers (e.g. layers 130, 150) including a first previous overlay layer (e.g. 130) and a first subsequent overlay layer (e.g. 150), wherein obtaining the first pair of overlay layers comprises aligning the first subsequent overlay layer to the first previous overlay layer according to the first set of values. For example, the first set of values can be used to create exposure recipes 184 for layers 130, 150 for step 610.

Operation (c) consists in applying the overlay measurement recipe to obtain a first set of one or more measurements (e.g. Measurement Data (1) in FIG. 7) indicating a degree of a conformance of the first pair of overlay layers to the first set of values.

Operation (d) consists in obtaining second data specifying a second set of one or more values for the one or more overlay parameters. For example, the second set of values may be Offset Data (2). In FIG. 7, Data (2) is obtained as equal or approximately equal to the negative of Measurement Data (1), but this is not necessary. In some embodiments, Data (2) can be predefined and independent of Measurement Data (1). In some embodiments, the second data may specify the second set of values indirectly like in the case of the first data as described above.

Operation (e) consists in obtaining a second pair of overlay layers including a second previous overlay layer (e.g. layer 130 of step 630) and a second subsequent overlay layer (e.g. 150), wherein obtaining the second pair of overlay layers comprises aligning the second subsequent overlay layer to the second previous overlay layer according to the second set of values. For example, the second set of values can be used to create exposure recipe or recipes 184 for step 630.

Operation (f) consists in applying the overlay measurement recipe to obtain a second set of one or more measurements (e.g. to obtain Measurement Data (3) in FIG. 7) indicating a degree of a conformance of the second pair of overlay layers to the second set of values.

Operation (g) consists in matching the first and second sets of values with the first and second measurements to determine if the overlay measurement recipe is reliable (as done at step 650 for example).

In some embodiments, said matching comprises testing, for at least one said parameter, that the difference between the second set of measurements and the first set of measurements is within predefined tolerance of the difference between the second set of values and the first set of values. For example, the matching may involve testing, for one or more of the parameters in FIG. 7, that the difference between Measurement Data (3) and Measurement Data (1) is within a predefined tolerance (e.g. 2 nm) of Offset Data (2). Of note, Offset Data (2) represents the difference between the second set of values and the first set of values in the example of FIG. 7 because the first set of values is zeroes. In other words, the matching may involve computing Measurement Data (3) minus Measurement Data (1) minus Offset Data (2), i.e. computing the negative of Data (5). Alternatively, the matching may involve computing Data (5). In either case, the absolute value of Data (5) is compared to the tolerance level of 2 nm. The predefined tolerance can be 2 nm for each parameter as explained above (with angular parameter values multiplied by the wafer radius and the ppm parameter values multiplied by the wafer radius and 10⁻⁶). In some embodiments, the predefined tolerance is some other value or set of values, with possibly different values for different parameters. For example, there may be a 2 nm tolerance value for the X-translation and a 2.5 nm tolerance value for the Y-translation. Further, weights can be assigned to the parameters. For example, the X-translation parameter can be more important than the R-Rot parameter. Therefore, the Data (5) values for the X-tran and R-Rot parameters may be multiplied by some weights, and the weight for X-tran can be greater than for R-Rot. The weighted sum can be compared to some value (e.g. 2 nm) to determine if the overlay measurement recipe is reliable. In some embodiments, instead of a weighted sum, some predefined polynomial can be computed in one or more of the Data (5) values and compared to a predefined value (e.g. 2 nm) to determine if the overlay measurement recipe is reliable. Further, a number of polynomials or other functions can be computed in one or more of the Data (5) values and compared against some predefined values. Alternatively, polynomials or other functions can be computed in the Data (2) values and in the differences between the Measurement Data (3) and Measurement Data (1), and/or in the first measurements (e.g. Measurement Data (1)), the second measurements (e.g. Measurement Data (3)), the first set of values, and the second set of values (e.g. Data (2)), and the computation results can be checked against some predefined values. The computations can be done by a computer or other circuitry which may or may not be part of analysis and control block 350. The invention is not limited to a particular type of matching except as defined by the appended claims.

In some embodiments, the overlay measurement recipe is modified if the overlay measurement recipe is determined in operation (g) to be unreliable.

In some embodiments, the first previous overlay layer is the same as the second previous overlay layer (e.g. the same layer 130 can be used in operations 610 and 630), but the first subsequent overlay layer is different from the second subsequent overlay layer (e.g. layers 150 may be different).

In some embodiments, in obtaining the first pair of overlay layers and obtaining the second pair of overlay layers, the first subsequent overlay layer and the second subsequent overlay layer are defined by the same optical mask (e.g. the same mask 174 of FIG. 1 can be used to define layers 150 at steps 610 and 630). In some embodiments, in obtaining the first pair of overlay layers and obtaining the second pair of overlay layers, one or both of (i) and (ii) are true, wherein:

(i) the first subsequent overlay layer and the second subsequent overlay layer are defined by the same optical mask;

(ii) the first previous overlay layer and the second previous overlay layer are defined by the same optical mask.

Maskless lithography can also be used. Thus, in some embodiments, in obtaining the first pair of overlay layers and obtaining the second pair of overlay layers, one or both of (i) and (ii) are true, wherein:

(i) the first subsequent overlay layer and the second subsequent overlay layer are defined by identical patterns except for differences between the first and second sets of values;

(ii) the first previous overlay layer and the second previous overlay layer are defined by identical patterns except for the differences between the first and second sets of values.

In each of (i) and (ii), the identical patterns may be defined by the same optical mask 174 (FIG. 1). Alternatively, if maskless lithography is used, the pattern in each layer can be defined by data, e.g. computer data, which may be part of exposure recipe 184. In each of (i) and (ii), the exposure recipe may be based on identical data except as defined by the differences in the first and second sets of values.

Some embodiments provide a method for checking an overlay measurement recipe, the method comprising the following operations (a) through (e). Operation (a) consists in obtaining a first pair of overlay layers including a first previous overlay layer (e.g. layer 130 of step 610) and a first subsequent overlay layer (e.g. 150).

Operation (b) consists in applying the overlay measurement recipe to obtain a first set of one or more measurements (e.g. Measurement Data (1)) for an alignment between the first previous overlay layer and the first subsequent overlay layer.

Operation (c) consists in obtaining a second pair of overlay layers including said first previous overlay layer (e.g. the same layer 130 as at step 610) and a second subsequent overlay layer (e.g. 150 at step 630), wherein the second subsequent overlay layer is obtained using one or more offset values (e.g. Offset Data (2) values) defining a position of the second subsequent overlay layer relative to a position of the first subsequent overlay layer.

Operation (d) consists in applying the overlay measurement recipe to obtain a second set of one or more measurements (e.g. Measurement Data (3)) for an alignment between the first previous overlay layer and the second subsequent overlay layer.

Operation (e) consists in matching the offset values with the first and second measurements to determine if the overlay measurement recipe is reliable.

In some embodiments, said matching comprises testing, for at least one said parameter, that a difference between the second set of measurements and the first set of measurements is within predefined tolerance of the offset values. Other types of matching are also possible, including polynomials or other functions in the first and second sets of measurements and the offset values.

In some embodiments, in obtaining the first pair of overlay layers and obtaining the second pair of overlay layers, the first subsequent overlay layer and the second subsequent overlay layer are defined by the same optical mask.

In some embodiments, in obtaining the first pair of layers and obtaining the second pair of layers, the first subsequent overlay layer and the second subsequent overlay layer are defined by identical patterns except for differences between the first and second sets of values.

The invention is not limited to the embodiments described above except as defined by the appended claims.

1. A method for checking an overlay measurement recipe, the method comprising:
(a) obtaining first data specifying a first set of one or more values for one or more overlay parameters, each overlay parameter specifying a property of an alignment of a subsequent overlay layer with respect to a previous overlay layer;
(b) obtaining a first pair of overlay layers including a first previous overlay layer and a first subsequent overlay layer, wherein obtaining the first pair of overlay layers comprises aligning the first subsequent overlay layer to the first previous overlay layer according to the first set of values;
(c) applying the overlay measurement recipe to obtain a first set of one or more measurements indicating a degree of a conformance of the first pair of overlay layers to the first set of values;
(d) obtaining second data a second set of one or more values for the one or more overlay parameters, the second set of values being different from the first set of values;
(e) obtaining a second pair of overlay layers including a second previous overlay layer and a second subsequent overlay layer, wherein obtaining the second pair of overlay layers comprises aligning the second subsequent overlay layer to the second previous overlay layer according to the second set of values;
(f) applying the overlay measurement recipe to obtain a second set of one or more measurements indicating a degree of a conformance of the second pair of overlay layers to the second set of values;
(g) matching the first and second sets of values with the first and second measurements to determine if the overlay measurement recipe is reliable.

2. The method of claim 1 wherein said matching comprises testing, for at least one said parameter, that a difference between the second set of measurements and the first set of measurements is within predefined tolerance of a difference between the second set of values and the first set of values.

3. The method of claim 1 further comprising modifying the overlay measurement recipe if the overlay measurement recipe is determined in operation (g) to be unreliable.

4. The method of claim 1 wherein the first previous overlay layer is the same as the second previous overlay layer but the first subsequent overlay layer is different from the second subsequent overlay layer; and
obtaining the second pair of the overlay layers comprises removing the first subsequent overlay layer and forming instead the second subsequent overlay layer.

5. The method of claim 4 wherein in obtaining the first pair of overlay layers and obtaining the second pair of overlay layers, the first subsequent overlay layer and the second subsequent overlay layer are defined by the same optical mask.

6. The method of claim 4 wherein in obtaining the first pair of overlay layers and obtaining the second pair of overlay layers, the first subsequent overlay layer and the second subsequent overlay layer are defined by identical patterns except for differences between the first and second sets of values.

7. The method of claim 1 wherein in obtaining the first pair of overlay layers and obtaining the second pair of overlay layers, one or both of (i) and (ii) are true, wherein:
(i) the first subsequent overlay layer and the second subsequent overlay layer are defined by the same optical mask;
(ii) the first previous overlay layer and the second previous overlay layer are defined by the same optical mask.

8. The method of claim 7 wherein both (i) and (ii) are true.

9. The method of claim 1 wherein in obtaining the first pair of overlay layers and obtaining the second pair of overlay layers, one or both of (i) and (ii) are true, wherein:
(i) the first subsequent overlay layer and the second subsequent overlay layer are defined by identical patterns except for differences between the first and second sets of values;
(ii) the first previous overlay layer and the second previous overlay layer are defined by identical patterns except for the differences between the first and second sets of values.

10. The method of claim 9 wherein both (i) and (ii) are true.

11. A method for checking an overlay measurement recipe, the method comprising:
(a) obtaining a first pair of overlay layers including a first previous overlay layer and a first subsequent overlay layer;
(b) applying the overlay measurement recipe to obtain a first set of one or more measurements for an alignment between the first previous overlay layer and the first subsequent overlay layer;
(c) obtaining a second pair of overlay layers including said first previous overlay layer and a second subsequent overlay layer, wherein the second subsequent overlay layer is obtained using one or more offset values defining a position of the second subsequent overlay layer relative to a position of the first subsequent overlay layer;
(d) applying the overlay measurement recipe to obtain a second set of one or more measurements for an alignment between the first previous overlay layer and the second subsequent overlay layer;
(e) matching the offset values with the first and second measurements to determine if the overlay measurement recipe is reliable.

12. The method of claim 11 wherein said matching comprises testing, for at least one said parameter, that a difference between the second set of measurements and the first set of measurements is within predefined tolerance of the offset values.

13. The method of claim 11 further comprising modifying the overlay measurement recipe if the overlay measurement recipe is determined in operation (e) to be unreliable.

14. The method of claim 11 wherein in obtaining the first pair of overlay layers and obtaining the second pair of overlay layers, the first subsequent overlay layer and the second subsequent overlay layer are defined by the same optical mask.

15. The method of claim 11 wherein in obtaining the first pair of layers and obtaining the second pair of layers, the first subsequent overlay layer and the second subsequent overlay layer are defined by identical patterns except for differences between the first and second sets of values.
